(19) United States
(12) Patent Application Publication
(10) Pub. No.: US 2012/0143438 A1
(43) Pub. Date: Jun. 7, 2012

(54) FIBER OPTIC VEHICLE COMMUNICATION SYSTEM

(75) Inventor: David HEIDEN, Clarkson, MI (US)

(73) Assignee: Nissan North America, Inc., Franklin, TN (US)

(21) Appl. No.: 12/957,975

(22) Filed: Dec. 1, 2010

(51) Int. Cl. H04B 10/12; G06F 19/00; B60Q 1/04

(52) U.S. Cl. 701/36; 398/141; 398/139; 701/1

(57) ABSTRACT

A vehicle communication system includes a fiber optic assembly and a cable assembly. The fiber optic assembly is configured to couple a controller to a plurality of vehicle components to enable communication of information between the controller and the vehicle components. The cable assembly extends from a vehicle power supply, with each of the vehicle components electrically coupling to a different respective location along the cable assembly to receive power from the vehicle power supply via the cable assembly. A portion of the fiber optic assembly and a portion of the cable assembly are mechanically coupled to each other such that the portion of the fiber optic assembly and the portion of the cable assembly collectively extend along the vehicle.

### BACKGROUND

1. Field of the Invention

The present invention generally relates to a vehicle communication system. More particularly, the present invention relates to a vehicle communication system using fiber optics to communicate with vehicle components.

2. Background Information

As vehicles become more technologically complex, the amount of communications that occur between a vehicle controller and vehicle components greatly increases. For example, some vehicle components include a controller or other programmable devices that frequently communicate with the vehicle controller during vehicle operation. Therefore, wiring is conventionally used to connect these types of vehicle components to the vehicle power supply, and additional wiring is required to connect these vehicle components to the vehicle controller. This additional wiring increases the weight of the vehicle and can occupy much space throughout the vehicle. Furthermore, this additional wiring is susceptible to damage and can result in additional maintenance costs.

Accordingly, there is a continuing need for an improved vehicle communication system that allows for efficient and effective communication between vehicle components.

### SUMMARY

In view of the state of known technology, one aspect of the present invention is to provide a fiber optic vehicle communication system including a fiber optic assembly and a cable assembly. The fiber optic assembly is configured to couple a controller to a plurality of vehicle components to enable communication of information between the controller and the vehicle components. The cable assembly extends from a vehicle power supply, with each of the vehicle components electrically coupling to a different respective location along the cable assembly to receive power from the vehicle power supply via the cable assembly. A portion of the fiber optic assembly and a portion of the cable assembly are mechanically coupled to each other such that the portion of the fiber optic assembly and the portion of the cable assembly collectively extend along the vehicle.

### BRIEF DESCRIPTION OF THE DRAWINGS

Referring now to the attached drawings which form a part of this original disclosure:

FIG. 1 is a schematic top plan view of a vehicle that is equipped with a vehicle communication system according to an embodiment described herein;

FIG. 2 is a more detailed exemplary schematic view of the vehicle communication system shown in FIG. 1;

FIG. 3 is a cross-sectional view of an exemplary arrangement of cables and fiber optics included in the vehicle communication system shown in FIG. 1; and

FIG. 4 is a schematic view of an exemplary coupling arrangement that couples a vehicle component to the vehicle communication system.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

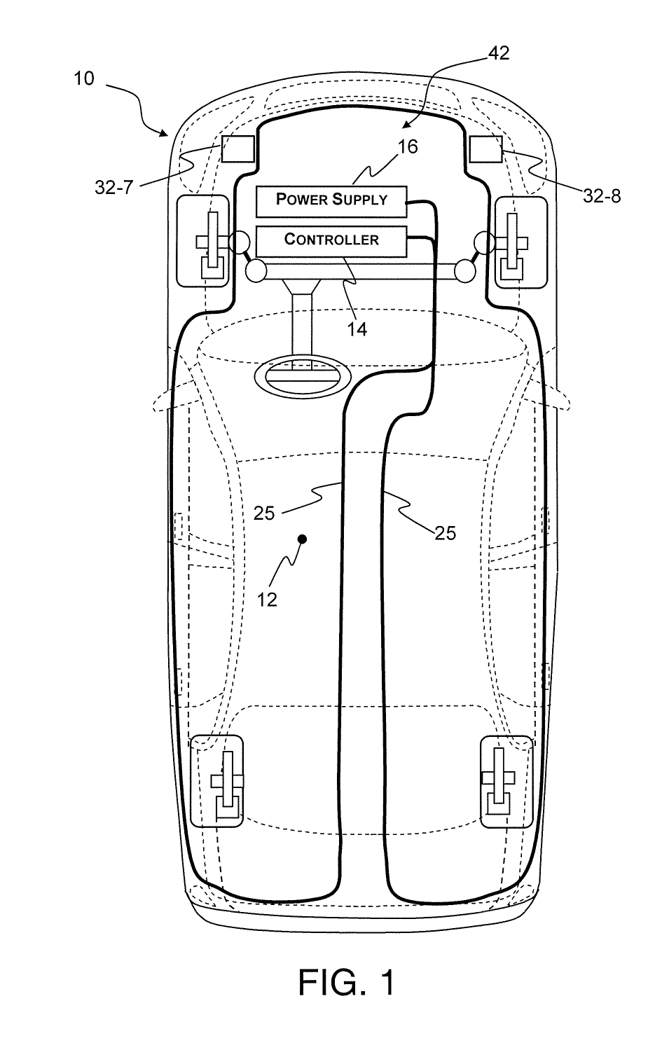

FIG. 1 illustrates an example of a host vehicle 10, such as an automobile, that is equipped with a vehicle communication system 12 in accordance with an illustrated embodiment. Although an automobile is illustrated, the term “vehicle” can refer to any type of vehicle such as a truck, motorcycle or other single or multi-wheeled terrestrial vehicles, a boat or other water vehicle, an airplane, helicopter or other aeronautical vehicle, machinery, and other industrial equipment, snow machine or winter sport vehicles, and the like.

Generally, the host vehicle 10 includes at least one controller 14 and a vehicle power supply 16. Also, the location of the controller 14 and vehicle power supply 16 in this example is merely for illustrative purposes. The controller 14 and vehicle power supply 16 can be installed at any suitable location within the host vehicle 10.

The controller 14 preferably includes a microcomputer with a control program that controls operations for controlling vehicle components as discussed below. The controller 14 can also include other conventional components such as an input interface circuit, an output interface circuit, and storage devices such as a ROM (Read Only Memory) device and a RAM (Random Access Memory) device which store processing results and the control program. For example, the internal RAM of the controller 14 stores statuses of operational flags and various control data, and the internal ROM of the controller stores the control program for various operations. The controller 14 is operatively coupled to the components discussed below in a conventional manner, and is capable of selectively controlling any of the components in accordance with the control program. It will be apparent to those skilled in the art from this disclosure that the precise structure and algorithms for the controller 14 can be any combination of hardware and software that will carry out the functions of the illustrated embodiment.

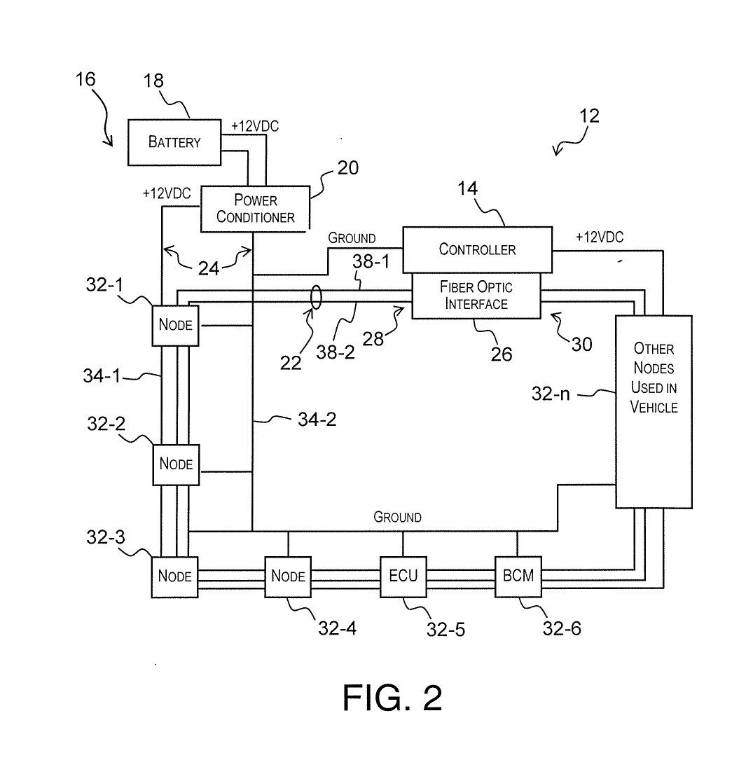

As shown in FIG. 2, the vehicle power supply 16 generally includes a battery 18, such as a standard 12 volt DC automotive battery, that is electrically coupled to, for example, an alternator system (not shown) that charges the battery 18 as understood in the art. The vehicle power supply 16 can also include a power conditioner 20 that improves the quality of the power that is delivered to the vehicle communication system 12 and the vehicle components as understood in the art. Hence, the battery 18 and power conditioner 20 can power components, such as the ignition components, when the vehicle 10 is not running, and the combination of the battery 18, power conditioner 20 and alternator can power vehicle components when the vehicle 10 is running.

As further shown in FIGS. 2-4, the vehicle communication system 12 includes a fiber optic assembly 22 and a cable assembly 24. The fiber optic assembly 22 is configured to couple to the controller 14 via, for example, a fiber optic interface 26. Hence, the fiber optic interface 26 is configured to couple the controller 14 to the fiber optic assembly 22 to enable communication of the information between the controller 14 and the fiber optic assembly 22. That is, as understood in the art, the fiber optic interface 26 converts electronic signals output from the controller 14 into optical signals for transmission through the fiber optic assembly 22, and converts optical signals into electronic signals for receipt by the controller 14. The fiber optic assembly 22 has a first end 28 and a second end 30, each coupled to the controller 14 via the fiber optic interface 26 in this example. Furthermore, although one fiber optic interface 26 is shown for illustrative purposes, any suitable number of fiber optic interfaces 26 can be used.

The fiber optic assembly 22 is further coupled to a plurality of vehicle components 32-1, 32-2, 32-3 . . . 32-n, that can also be referred to collectively as vehicle components 32 or nodes 32 of the vehicle communication system 12. In this example, the host vehicle 12 is an automobile, the vehicle components 32 are automobile components, and the fiber optic assembly 22 is configured to provide communication of the information between the controller 14 and the automobile components. The information generally travels through the fiber optic assembly 22 at or about the speed of light. Thus, there is effectively no delay in transmission of information between the controller 14 and the vehicle components 32.

Each of the vehicle components 32 is coupled to a respective intermediate location along the fiber optic assembly 22 between the first and second ends 28 and 30. The vehicle components 32 can include, for example, an engine control unit (ECU) identified as vehicle component 32-5, a body control unit (BCU) identified as vehicle component 32-6, a vehicle headlight assembly, a brake assembly, and any other component in the host vehicle 10. Generally, there are four different types of vehicle components or nodes 32 in this example. Each vehicle component or node 32 can be programmable to operate as a intelligent switch, such as an IP switch as known in the art, a data gathering engine, a subprocess controller, and a human interface (e.g., a driver input). Accordingly, the fiber optic assembly 22 enables communication of information between the controller 14 and the different types of vehicle components 32 as discussed in more detail below. Specifically, the fiber optic assembly 22 is configured to enable bidirectional communication of the information between the first and second ends 28 and 30.

Furthermore, the controller 14 can perform an addressing or mapping operation to identify the individual vehicle components 32 in a manner as understood in the art. This addressing or mapping operation can be performed in accordance with known Transmission Control Protocol/Internet Protocol (TCP/IP) techniques used in nodal networking, or in any other suitable manner. Accordingly, each vehicle component 32 can be assigned an individual address, such as an IP address, that enables the controller 14 to address messages to a particular vehicle component 32, and enables the particular vehicle component 32 to identify and thus receive messages addressed to that node 32. Thus, each communication from the controller 14, or from a vehicle component 32, includes address or identification information that identifies the source and/or destination of the communication. In addition, when a vehicle component 32 is removed or replaced, or a new vehicle component 32 is added, the vehicle communication system 12 (e.g., the controller 14) can perform the addressing or mapping operations to update the addressing of the vehicle components 32. A user can also enter information pertaining to the vehicle component 32 via, for example a user interface (e.g., a touch screen within the passenger compartment of the vehicle) of the vehicle communication system 12. Naturally, the addressing or mapping operation can also be performed at any suitable time during operation of the host vehicle 10 (e.g., to insure that the vehicle components 32 are connected and operating properly).

As further illustrated, the cable assembly 24 extends from the vehicle power supply 16, with each of the vehicle components 32 electrically coupling to a different respective location along the cable assembly 24 to receive power from the vehicle power supply 16 via the cable assembly 24. Generally, the diameter of the cable assembly 24 should be the same or substantially the same throughout the length of the cable assembly 24 to avoid, for example, the generation of unnecessary capacitance in the cable assembly 24. Furthermore, a portion of the fiber optic assembly 22 and a portion of the cable assembly 24 are mechanically coupled to each other as a assembly 25 such that the portion of the fiber optic assembly 22 and the portion of the cable assembly 24 in assembly 25 collectively extend along the host vehicle 12 as shown schematically in FIGS. 1 and 2. The assembly 25 is secured, for example, at various locations of the chassis of the host vehicle 10 to provide mechanical stability for the assembly 25 and to allow for electrical connection of the chassis to, for example, the ground conductor of the cable assembly 24.

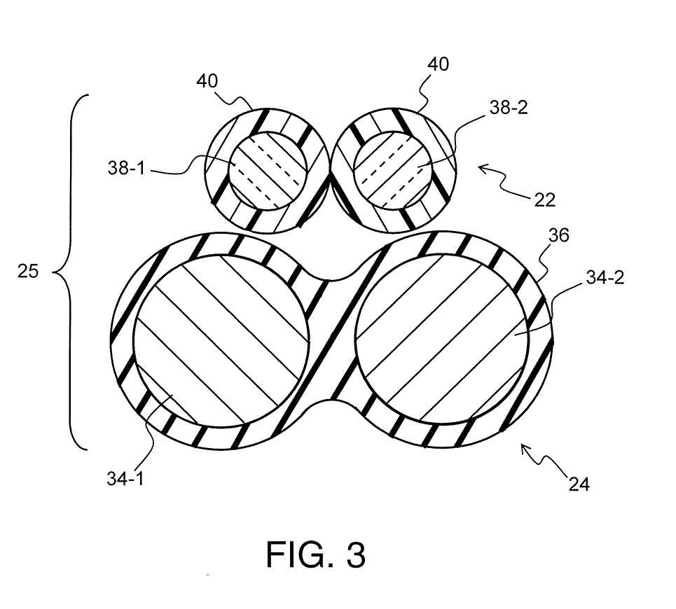

That is, as shown in more detail in FIG. 3, the cable assembly 24 includes a plurality of electrical conductors 34-1 and 34-2 that extend collectively along the cable assembly 24. Each conductor 34-1 and 34-2 can include, for example, a plurality of #10 fine strand wire, or any other type of cable of a suitable gauge. Hence, the electrical conductors 34-1 and 34-2 can be referred to as first and second electrical conductor bundles. Also, two conductors 34-1 and 34-2 are shown for illustrative purposes, with one conductor (e.g., conductor 34-1) being used to supply the positive voltage from the vehicle power supply 16 and the other conductor (e.g., conductor 34-2) being used as ground. Hence, the conductor 34-1 can include red #10 fine strand wire, for example, and the conductor 34-2 can include black #10 fine strand wire. However, the cable assembly 24 can include any suitable number of conductors. As discussed above, generally, the diameter of each conductor 34-1 and 34-2 should be the same or substantially the same throughout the length of the cable assembly 24 to avoid, for example, the generation of unnecessary capacitance in the cable assembly 24. Furthermore, the conductors 34-1 and 34-2 can be mounted together by an insulating conduit 36 as known in the art. It should also be noted that the cable assembly 24 can be configured to include fiber optic cables that are configured for power transmission as known in the art. These fiber optic cables can be used instead of conductors 34-1 and 34-2 or in addition to conductors 34-1 and 34-2.

The fiber optic assembly 22 includes a plurality of fiber optic pipes 38-1 and 38-2 collectively extending along the fiber optic assembly 22 between the controller 14 and the plurality of vehicle components 28. Each fiber optic pipe 38-1 and 38-2 in this example includes a plurality of micro size optical fibers, such as plastic fibers, bundled together to form the larger pipe 38-1 or 38-2. Hence, the first and second fiber optic pipes 38-1 and 38-2 can also be referred to as first and second fiber optic bundles. The use of multiple fiber optic pipes 38-1 and 38-2 including a plurality of optical fibers increases durability of the pipes 38-1 and 38-2, because the pipes 38-1 and 38-2 can maintain communication even if one or more fibers or an entire pipe become broken or damaged. Also, two fiber optic pipes 38-1 and 38-2 are shown for illustrative purposes. However, the fiber optic assembly 22 can include any suitable number of fiber optic pipes 38-1 and 38-2. Furthermore, the fiber optic pipes 38-1 and 38-2 can be mounted together by a protective conduit 40 as known in the art.

In this example, the fiber optic assembly 22 extends along the top of the cable assembly 24 in the host vehicle 12. However, the fiber optic assembly 22 can be positioned below the cable assembly 24, or along a side of the cable assembly 24. Furthermore, one fiber optic pipe 38-1 can extend along the top, bottom or one side of the cable assembly 24, and the other fiber optic pipe 38-2 can extend along the top, bottom or side of the cable assembly 24. In other words, the fiber optic pipes 38-1 and 38-2 can be configured to extend along the cable assembly 24 in any suitable manner. Also in this example, a portion of the fiber optic assembly 22 and the portion of the cable assembly 24 collectively extend within an engine compartment 42 of the host vehicle 10.

Accordingly, as can be appreciated from the above, the first fiber optic bundle 38-1 and the first electrical conductor bundle 34-1 are configured to collectively extend along the host vehicle 12, and the second fiber optic bundle 38-2 and the second electrical conductor bundle 34-2 are configured to collectively extend along the host vehicle 12. Thus, the first and second fiber optic bundles 38-1 and 38-2 and the first and second conductor bundles 34-1 and 34-2 are mechanically coupled to each other to extend collectively along a portion of the host vehicle 12.

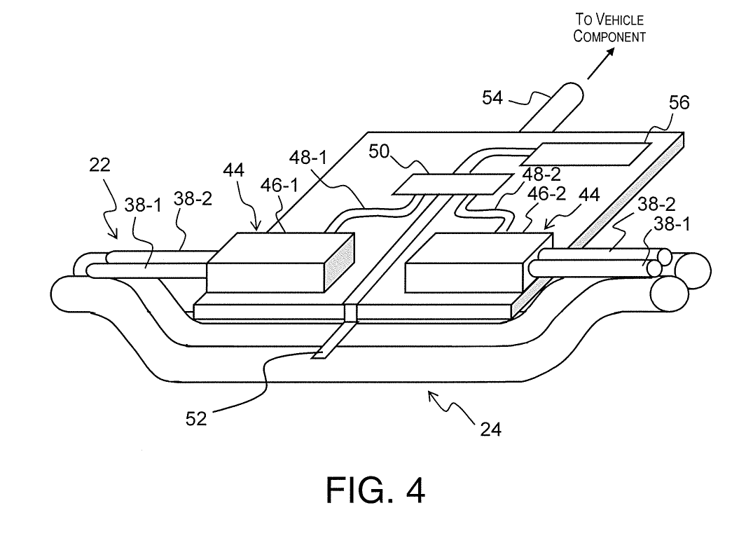

It should be further noted that the each of the vehicle components 32 in this example is coupled to the fiber optic assembly 22 by an optical transceiver assembly 44. An example of an optical transceiver assembly 44 is shown in FIG. 4. As indicated, an optical transceiver assembly 44 includes an optical transceiver 46-1 that couples fiber optic pipes 38-1 and 38-2 to a vehicle component 32, and an optical transceiver 46-2 that also couples fiber optic pipes 38-1 and 38-2 to the vehicle component 32. Each of the optical transceivers 38-1 and 38-2 couples the fiber optic assembly 22 to a conductive component 48-1 and 48-2 (or to the same conductive component 48) that is electrically coupled to the vehicle component 32.

That is, optical transceivers 46-1 and 46-2 each operate as a fiber optic interface couple the vehicle component 32 to the fiber optic assembly 22 to enable communication of the information between the controller 14 and the vehicle component 32 via the fiber optic assembly 22. That is, as understood in the art, the optical transceivers 46-1 and 46-2 convert optical signals received from the fiber optic assembly 22 into electronic signals for receipt and use by the vehicle component 32. The optical transceivers 46-1 and 46-2 also convert electronic signals output by the vehicle component 32 into optical signals for transmission through the fiber optic assembly 22 for receipt by the controller 14. Hence, the optical transceivers 46-1 and 46-2 enable bidirectional communication through the fiber optic assembly 22. The communication can occur over both fiber optical pipes 38-1 and 38-1 in a redundant manner. Thus, the fiber optic vehicle communication system 12 can operate as a parallel computer structured to include two rings of fiber optical pipes 38-1 and 38-2.

As further shown in FIG. 4, a vehicle component 32 can include a controller 50 which is configured to control the vehicle component 32 based on the information received from the controller 14. The controller 50 can include components similar to controller 14 as discussed above. Accordingly, the controller 14 can transmits information addressed to a vehicle component 32 or vehicle components 32 over the fiber optic assembly 22. The information can be transmitted as, for example, addressed TCP/IP messages as understood in the art. When a controller 50 of a vehicle component 32 receives and identifies information as being addressed to that particular vehicle component 32, the controller 50 can control that vehicle component 32 in accordance with that information. Also, controllers 50 of different vehicle components 32 can communicate with each other over the fiber optic assembly 22.

Furthermore, controller 14 and controllers 50 are capable of performing artificial intelligence (AI) type operations. For example, the controller 50 can send information to the controller 14 suggesting activation of the headlamps when a certain level of ambient illumination is detected. Also, the artificial intelligence in the controller 14 and controllers 50 can perform operations which, for example, enable the host vehicle 10 to “limp home” after an accident.

In addition, each vehicle component or node 32 can plug into a connector at a location along the cable assembly 24 to receive power from the power supply 16 via the cable assembly as shown in FIG. 4. That is, the vehicle component or node 32 can have a connector on, for example, its bottom surface or at any other location, which enables the vehicle component or node 32 to plug into a connector on the cable assembly 24. Also, a short electrical conductor 52 (e.g., several millimeters long) can electrically couple the vehicle component 32 to the cable assembly 24. Furthermore, the components shown in FIG. 4 need not be located directly on the vehicle component 32 (e.g., a headlight assembly), but rather, a short conductor assembly 54 (e.g., several millimeters long) can couple the components shown in FIG. 4 to the vehicle component 32 being controlled by controller 50. In any event, it is unnecessary to electrically couple a vehicle component 32 directly to the power supply 16 independent of the cable assembly 24. Accordingly, the amount of wiring used in the host vehicle 10 can be greatly reduced.

For example, at least one of the vehicle components or nodes 32 can include or be associated with a vehicle headlight assembly 32-7 or 32-8 as shown in FIG. 1. The information transmitted by the controller 14 includes a command for controlling operation of the vehicle headlight assembly 32-7 and/or 32-8. Hence, when the controller 50 of vehicle headlight assembly 32-7 receives the information, the controller 50 controls the vehicle headlight assembly 32-7 to operate in accordance with that information (e.g., the vehicle headlight assembly 32-7 can turn on the high beams).

In addition, since the fiber optic assembly 22 allows for bidirectional communication between the vehicle components 32 and the controller 14, the fiber optic assembly 22 enables communication of information from at least one of the vehicle components 32 to the controller 14. That is, the controller 50 of the vehicle component 32 can transmit the information over the fiber optic assembly 22. That information can include information representing a condition of the vehicle component 32. For example, if the vehicle component 32 is associated with a headlight assembly, the information can include information indicating whether the headlight assembly has the high beams or low beams activated.

Moreover, one or more of the vehicle components 32 can include a power switch 56, such as a power field effect transistor (FET) or any other suitable component. The power switch 56 selectively controls powering of the vehicle component 32. Hence, the fiber optic assembly 22 enables communication of information from the controller 14 to the controller 50 of the vehicle component 32. The controller 50 can thus control the power switch 56 associated with that vehicle component 32 to provide the power from the cable assembly 24 to that vehicle component 32, or any other vehicle component associated with that vehicle component 32. For instance, the controller 14 can send control information via the fiber optic assembly 22 for receipt by the controller 50 to control the power switch 56 to supply power to the headlamp assembly.

Accordingly, as can be appreciated from the above, the use of a fiber optic assembly 22 reduces the amount of wiring that is used in the host vehicle 10. This reduction in wiring can reduce the overall weight of the host vehicle 10 by, for example, 200 pounds or more. Also, since there is less wiring that is susceptible to damage or other failure, the reliability and serviceability of the host vehicle 10 is improved.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with components for performing the operations discussed herein. Accordingly, these terms, as utilized to describe the present invention should be interpreted relative to a vehicle equipped with the components for performing the operations discussed herein. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A fiber optic vehicle communication system, comprising:
a fiber optic assembly configured to couple a controller to a plurality of vehicle components to enable communication of information between the controller and the vehicle components; and
a cable assembly extending from a vehicle power supply, with each of the vehicle components electrically coupling to a different respective location along the cable assembly to receive power from the vehicle power supply via the cable assembly; and
a portion of the fiber optic assembly and a portion of the cable assembly are mechanically coupled to each other such that the portion of the fiber optic assembly and the portion of the cable assembly collectively extend along the vehicle.

2. The fiber optic vehicle communication system according to claim 1, wherein
the cable assembly includes a plurality of electrical conductors extending collectively along the cable assembly.

3. The fiber optic vehicle communication system according to claim 1, wherein
the portion of the fiber optic assembly and the portion of the cable assembly collectively extend within an engine compartment of the vehicle.

4. The fiber optic vehicle communication system according to claim 1, wherein
the fiber optic assembly includes a plurality of fiber optic strands collectively extending between the controller and the plurality of vehicle components.

5. The fiber optic vehicle communication system according to claim 1, further comprising
a plurality of optical transceivers, each configured to couple the fiber optic assembly to a respective one of the vehicle components.

6. The fiber optic vehicle communication system according to claim 5, wherein
each of the optical transceivers couples the fiber optic assembly to a respective conductive component electrically coupled to one of the respective vehicle components.

7. The fiber optic vehicle communication system according to claim 1, wherein
the fiber optic assembly has first and second ends, each coupled to the controller, with each of the vehicle components being coupled to a respective intermediate location along the fiber optic assembly between the first and second ends.

8. The fiber optic vehicle communication system according to claim 7, wherein
the fiber optic assembly is configured to enable bidirectional communication of the information between the first and second ends.

9. The fiber optic vehicle communication system according to claim 1, wherein
at least one of the vehicle components include a vehicle headlight assembly; and
the information includes a command for controlling operation of the vehicle headlight assembly.

10. The fiber optic vehicle communication system according to claim 1, wherein
at least one of the vehicle components includes a second controller which is configured to control the at least one of the vehicle components based on the information received from the controller.

11. The fiber optic vehicle communication system according to claim 1, further comprising
a fiber optic interface configured to couple the controller to the fiber optic assembly to enable communication of the information between the controller and the fiber optic assembly.

12. The fiber optic vehicle communication system according to claim 1, wherein
the fiber optic assembly enables communication of a portion of the information from at least one of the vehicle components to the controller, with the portion of the information including information representing a condition of the at least one of the vehicle components.

13. The fiber optic vehicle communication system according to claim 1, wherein
the fiber optic assembly enables communication of a portion of the information from the controller to one of the vehicle components to control the one of the vehicle components to receive the power via the cable assembly.

14. The fiber optic vehicle communication system according to claim 13, further comprising
a plurality of power switches, each associated with a respective one of the vehicle components; and
the fiber optic assembly enables communication of the portion of the information from the controller to the power switch associated with the one of the vehicle components to control the power switch to provide the power from the cable assembly to the one of the vehicle components.

15. The fiber optic vehicle communication system according to claim 1, wherein
the fiber optic assembly includes first and second fiber optic bundles, and the cable assembly includes first and second electrical conductor bundles; and
the first fiber optic bundle and the first electrical conductor bundle are configured to collectively extend along the vehicle, and the second fiber optic bundle and the second electrical conductor bundle are configured to collectively extend along the vehicle.

16. The fiber optic vehicle communication system according to claim 15, where
the first and second fiber optic bundles and the first and second conductor bundles extend collectively along a portion of the vehicle.

17. The fiber optic vehicle communication system according to claim 1, wherein
the vehicle is an automobile, the vehicle components are automobile components, and the fiber optic assembly is configured to provide communication of the information between the controller and the automobile components.

18. A fiber optic vehicle communication system, comprising
a controller;
a plurality of vehicle node components;
a fiber optic assembly configured to couple the controller and vehicle node components to each other to enable communication of information between the controller and the vehicle components; and
a cable assembly extending from a vehicle power supply, with each of the vehicle node components electrically coupling to a different respective location along the cable assembly to receive power from the vehicle power supply via the cable assembly; and
a portion of the fiber optic assembly and a portion of the cable assembly are mechanically coupled to each other such that the portion of the fiber optic assembly and the portion of the cable assembly collectively extend along the vehicle between the controller and the plurality of vehicle node components.

19. The fiber optic vehicle communication system according to claim 18, wherein
a plurality of optical transceivers, each configured to couple the fiber optic assembly to a respective one of the vehicle components.

20. The fiber optic vehicle communication system according to claim 18, wherein
the fiber optic assembly has first and second ends, each coupled to the controller, with each of the vehicle node components being coupled to a respective intermediate location along the fiber optic assembly between the first and second ends, such that the fiber optic assembly is configured to enable bidirectional communication of the information between the controller and the vehicle node components.
